(19) United States
(12) Patent Application Publication
(10) Pub. No.: US 2003/0083912 A1
(43) Pub. Date: May 1, 2003

(54) Optimal resource allocation business process and tools

(76) Inventors: Roy B. Covington III, Charlotte, NC (US); Patricia E. Fagley, Charlotte, NC (US); Mamnoon Jamil, Voorhees, NJ (US); Daniel J. Peters, Poughquag, NY (US)

Correspondence Address: FREDERICK W. GIBB, III, MCGINN & GIBB, PLLC, 2568-A RIVA ROAD, SUITE 304, ANNAPOLIS, MD, 21401, US

(21) Appl. No.: 09/999,866

(22) Filed: Oct. 25, 2001

(51) Int. Cl. G06F 17/60

(52) U.S. Cl. 705/7

(57) ABSTRACT

A disciplined and rigorous method and structure for optimally allocating resources to projects within a business unit is disclosed. The method evaluates current and future projects with associated tools. The method prepares a matrix of performance measurements, desired level of performance (synthesized business model) and management functions. The method assesses the matrix for consolidation of projects and the requirement for additional projects after consolidation. The method incorporates benchmarking process, and attribute listings to identify key process and performance gaps.

### BACKGROUND OF THE INVENTION

1. Field of the Invention

The present invention generally relates to project management, process reengineering, e-business and consultancy. Specifically, the invention is a process and tools for integrating performance measures and management functions with a business unit's projects, initiatives, investments, and business model.

2. Description of the Related Art

There are many industry specific models (used by both profit and nonprofit organizations) available for business reengineering and consultancy. These models are quantitative or qualitative in nature. In some cases, the models have both characteristics. In some quantitative models, a benchmarking component is provided to assess the physical, financial, and operational performance of the business unit.

The traditional method of evaluating projects, initiatives and investments (hence, referred to as projects throughout this document) of the business unit was to compile a list of projects and place them in some prioritized manner based on return on investment, etc., without the rigor of a business model methodology. Traditional methods of solving this problem have not integrated performance measurements, management functions, and the business model. This lack of integration did not provide the essential coherency and focus demanded by management.

The principal challenge toward solving the foregoing problems is visualizing the impact of current and future projects, and driving effective transformation efforts based on the business model, performance measurements, and management functions. A rigorous business process, set of techniques, criteria and tools are required to prioritize projects and allocate resources optimally in the context of the overall business strategy.

### SUMMARY OF THE INVENTION

A combination of business processes and tools described below integrate a business unit's projects into the performance measurements, management functions, and business model. The optimal resource allocation business process includes a set of characterization criteria, prioritization techniques and analytic tools. The tools are: (1) Project Matrix, (2) Project Summary Chart, (3) Individual Project Worksheet, (4) Project Listing, and (5) Core and e-Business Process & Attribute Listing. When the optimal resource allocation business process is employed, the consultants (internal or external) will use the tools with key business personnel and project leaders. The consultants complete the Project Listing, Project Summary Charts and Project Matrix using the Individual Project Worksheets and Core and e-Business Process & Attribute Listing. In concert with the business unit's executives, the consultants apply the analytical methods and criteria to the business process, especially to the Project Matrix and Project Summary Charts to improve execution and close both end-to-end (e2e) core business and e-business gaps. The business process prioritizes and allocates resources accordingly.

The business process does this by evaluating current and future projects, analyzing the supporting business cases, identifying performance gaps, determining current project impacts, conducting appropriate reallocations of resources to all current and future projects, and providing a structured periodic review process. This business process with associated tools creates an ongoing culture of continuous improvement which is the best practice for business reengineering. The goals are to enhance business efficiency, drive business transformation smoothly, create improved market value, and develop industry leadership.

The invention also includes the method of evaluating projects. The invention completes a project matrix by assigning projects to matrix elements. The matrix elements include performance measures, each associated with a plurality of management functions. The invention establishes desired performance levels for the performance measures. The invention also determines actual performance levels achieved for each of the management functions within each of the performance measures. Further, the invention compares the actual performance levels and the desired performance levels to identify benchmarking gaps. The invention determines a sufficiency of resources to close the benchmarking gaps.

The invention also consolidates selected projects within the matrix element. The invention identifies additional projects to supplement selected projects within the matrix elements. The consolidating process and the process of identifying additional projects limits a number of projects within each of the matrix elements to maintain management focus. Each of the performance measures includes more than one of the management functions. The project matrix includes between 3 and 6 performance measures and between 3 and 6 management functions. The actual performance levels include inferior, comparable, superior, and world-class leadership. The desired performance levels include comparable, superior, and world-class leadership. One of the performance measures has a world-class leadership desired performance level. One of the performance measures has a superior desired performance level, and remaining ones of the performance measures have comparable desired performance levels.

The invention advances the consultancy field by characterizing the business unit's projects in management function and performance measurement terms, and incorporates the business model, process, attribute, and benchmarked gaps. The intention of this process and Project Matrix is to go beyond providing project status to prioritization of existing and future activities, development of actionable projects, and improvement of business performance. A benchmarking study quantifies the gap between desired and actual current performance, and is direction setting in nature. The optimal resource allocation business process in conjunction with the Project Matrix identities and prioritizes the activities in each management function and performance measurement element of the matrix, and identifies elements of the matrix with insufficient activities to close the gaps. The business process employs analytic techniques and tools to achieve an optimal set of projects that ensures alignment with the business model.

### BRIEF DESCRIPTION OF THE DRAWINGS

The foregoing and other objects, aspects and advantages will be better understood from the following detailed description of a preferred embodiment(s) of the invention with reference to the drawings, in which:

FIG. 1 is a schematic diagram of a Project Matrix;

FIG. 2 is a schematic diagram of a Project Summary Chart;

FIG. 3 is a schematic listing of an Individual Project Worksheet;

FIG. 4 is a schematic diagram of a Project Listing;

FIG. 5 is a schematic diagram of a Core and e-Business Process & Attribute Listing;

FIG. 6 is a flow diagram illustrating key elements of the invention;

FIG. 7 is a flow diagram illustrating major elements of the invention;

FIGS. 8a, 8b, and 8c are flow diagrams illustrating the detailed processes of the invention;

FIG. 9 is a legend for the flow diagrams; and

FIG. 10 is a schematic diagram of a computer system that can be used with the invention.

### DETAILED DESCRIPTION OF PREFERRED EMBODIMENTS OF THE INVENTION

The business process, associated criteria and tools are used to allocate resources optimally to prioritized projects. The business process allocates scarce resources based on the business model, identified gaps, and various tools. The optimal resource allocation business process in conjunction with the tools assist managers in the requisite prioritization effort to transform the business to compete in the open market environment, and aligns the necessary efforts with the business model. The optimal resource allocation business process provides: evaluation of current and future projects, analysis of supporting business cases, prioritization of projects based upon various criteria such as Return on Investment (ROI), milestones achieved, resources committed, etc., reallocation of resources to approved projects based upon a prioritization scheme, and periodic structured management reviews.

It is common for companies to conduct business unit assessments using various models, tools and benchmarking studies. Gap analyses (i.e., analysis of areas where improvement is needed) are often concurrently requested by business unit executives. Each business unit has a different business model based on the industry segment, competitive environment, and value proposition. The current and future projects must be placed in context of the business model and the major gaps that need to be closed. A gap analysis assists executives in providing prioritization of projects and optimal allocation of resources, ensuring the largest impact possible based upon the business model and benchmarking, and focusing on the end-to-end core and e-business processes and attributes performance gaps. This invention provides a gap analysis process to meet those prioritization and allocation concerns of business unit executives. The Project Matrix overlays all activities underway or in the business plan that may impact on closing these gaps. The matrix provides insight into which activities require additional investment, new projects, consolidation, divestiture, resourced at a reduced level, etc. Based upon the benchmarking, analytic tools and the Project Matrix, the consultants provide sized opportunities to a business unit.

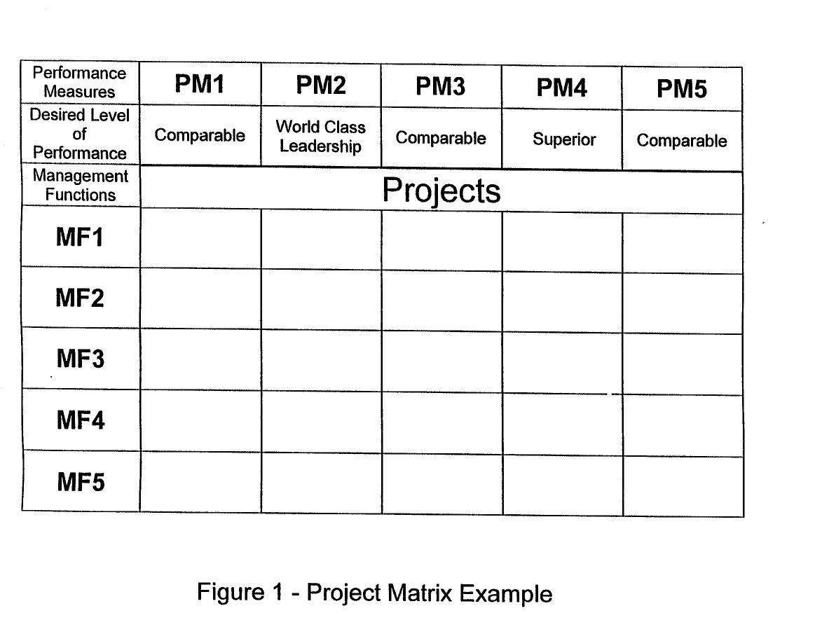

An important feature of the invention is the utility of the Project Matrix tool which is portrayed in FIG. 1. The Project Matrix is developed in conjunction with the business unit and the business areas to be assessed. There are four main components of the matrix.

First, the top row represents performance measurements (PM1-PM5, etc.) which consist of key evaluation metrics for business success. Selection criteria for performance measures are determined by the business unit, competitive evaluations, type of assessment, type of benchmarking study to be conducted, etc. The effective number of performance measurements preferably range from 3 to 6 depending on the selection criteria. Examples of performance measures are cost, revenue growth, inventory, number of feature codes, number of models, on time delivery, etc. Such measures are compared to the abilities of competitors in the marketplace and the organization's performance with respect to these measures rated as follows: (1) world-class leadership, (2) superior, (3) comparable, and (4) inferior.

Second, the row below the performance measurements represents the desired level of performance characteristics. These performance characteristics are a reflection of the business model imperatives (i.e., world-class leadership and superior performance) and equality (not the basis of keen competition, but important). These desired performance characteristics are categorized, for example, as follows: (1) world-class leadership, (2) superior, and (3) comparable. World-class leadership pertains to only one performance measurement area to ensure focus on a specific area of performance. World-class leadership ensures that the business will drive towards outstanding results over key competitors and toward consonance with the business model. Superior performance pertains to only one performance measurement area that is required for a competitive advantage over the majority of competitors. Comparable performance pertains to the remaining performance measurements (not world-class leadership or superior performance). These comparable performance measurements require similar performance to the average competitor.

The business model and the desired level of performance is developed through a series of detailed interviews with key executives, managers, and technical personnel within the business unit. These interviews will define the core business model, the competitive environment, business imperatives, and enablers which are synthesized together as desired levels of performance. If a benchmarking survey is completed, it will provide a gap analysis in Actual Performance (AS IS) and the Desired Level of Performance (TO BE). The benchmarking study will quantify performance in physical terms such as process metrics (i.e., cycle times or asset utilization), or financial data (i.e., the magnitude of the opportunity in potential cost savings) between the AS IS and TO BE environments.

To win in the marketplace requires a focused business model and world-class leadership performance in one of the performance measurements. The rationale for this approach is that a business can not achieve world-class leadership in all performance measurements. The principal reasons are: (1) resources are limited, (2) there are very distinct resources and impact tradeoffs between performance measurements, and (3) to achieve world-class performance in every category is not necessary to adequately compete in the marketplace. Therefore, critical management attention must be focused on one to two key performance measurement areas, and these two areas need to be prioritized as world-class leadership and superior. Otherwise, there would be lack of focus resulting in diffused energy applied across the board, which would not achieve a distinct competitive advantage. The lack of focus transforms a company into an average level of performance. Competition does not always have to be head-to-head, it can be asymmetrical to achieve marketplace success. Regardless of approach to the competition, relentless focus on a few key metrics is essential for attaining business objectives and world-class leadership.

Third, the left column represents management functions which have major process groupings. Selection criteria for management functions are determined by the business unit, type of assessment, competitive environment, type of benchmarking study to be conducted, etc. The effective number of management functions (MF1-MF5, etc.) that preferably range from 3 to 6 depending on the selection criteria. Examples of management functions are planning, manufacturing, fulfilling, etc.

Fourth, all of the current and future projects are listed for evaluation through this business process. Each project is unique as to its impact on the performance measurement and management function (Project Matrix) elements in conjunction with the business objectives. A project can have an impact on one or more of the matrix elements. However, most projects will not have an impact on all matrix elements. If this occurs, the selection of the performance measurements and management functions is too narrow. In this case, the business unit should go back and reassess the selection of performance measurements and management functions, and take a broader and strategic view of their business.

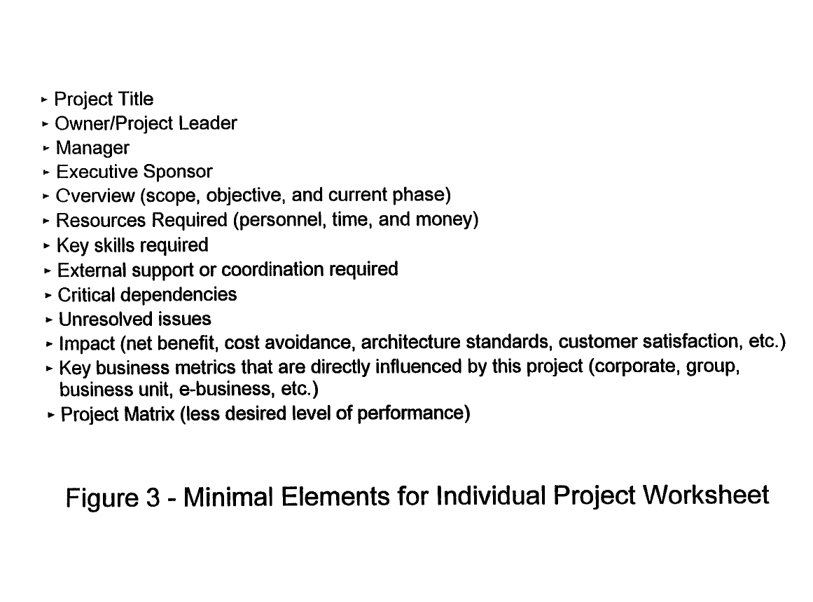

The impact of the project will be assessed in conjunction with the project leaders on the Individual Project Worksheet (refer to FIG. 3). The placement or internal prioritization of projects within each matrix element is based upon the business unit's management system. The impact criteria of the projects may be color coded or assigned high, medium or low categories. The direct impact of each project is placed in each performance measurement and management function element. This portion of the Project Matrix will be updated throughout the business process as key criteria are applied to various projects, either singularly or in concert with others.

The size of the Project Matrix depends on the number of performance measurements and management functions selected for these periodic reviews. An excessive number of rows or columns should be an indicator that management functions or performance measurements should be consolidated under more comprehensive terms. Performance measurements and management functions can be added, deleted, or consolidated in the Project Matrix as appropriate. This adaptable matrix provides a visceral bridge from the performance measurements and management functions to the business model, which benefits executives and consultants.

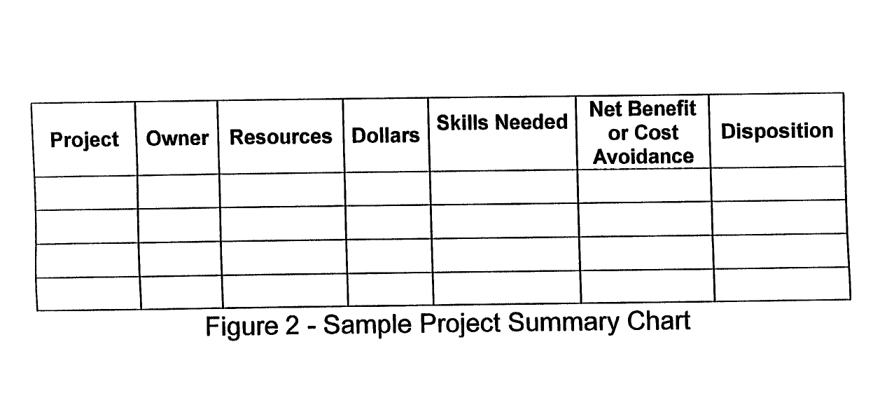

The Project Summary Chart provides critical data points for each project and is portrayed in FIG. 2. The Individual Project Worksheets (FIG. 3) are rolled up into this intermediate Project Summary Chart. These Project Summary Charts provide a synopsis of the project's owner, costs, benefits, resources needed, skills needed, and project disposition. Project disposition indicates the prioritization or status of the project. Examples include implementation, acceleration, sustainment, postponement, deferral, divestiture, consolidation, realignment, etc., of projects. The disposition will be the consensus recommendation from the executives, managers, technical personnel and project leaders during the periodic review process (part of the management system).

The Project Summary Chart can be used as an intermediate analytic tool. The project owners may be saturated with projects that preclude effective management and timely completion. In this case, projects may be reassigned to appropriate owners to balance the workload within the business unit. The identification of critical skills needed to complete the projects may indicate competition over a scarce enabling resource that would have to be adjudicated and prioritized, or a requirement for additional training. The Summary Chart may also indicate a need to reorganize the business unit as the focus of the business shifts with emerging opportunities or other business imperatives. Additional benefits of the Project Summary Charts are: (1) determination of the requirements of new or revised personnel groupings to execute the projects properly, (2) assurance of management oversight, and (3) identification of critical resources which are constrained or have major dependencies on other projects.

The Individual Project Worksheet catalogs basic project information. The minimal elements for this worksheet are contained in FIG. 3. The Individual Project Worksheet includes the following elements to gather the requisite information to analyze each project properly. The elements are project title, owner/project leader, manager, executive sponsor, overview (scope, objective, and current phase), resources required (personnel, time, and money), key skills required, external support or coordination required, critical dependencies, unresolved issues, impact (net benefit, cost avoidance, architecture standards, customer satisfaction, etc.), key business metrics that are directly influenced by this project (corporate, group, business unit, e-business, etc.), and project matrix (less desired level of performance).

The consultants and executives review the desired level of performance in the Project Matrix independently of the Individual Project Worksheets being completed. The identification of the desired level of performance only in the Project Matrix ensures the independence of each work stream.

The worksheet format provides sufficient details for analysis. The consultant team completes the worksheet in conjunction with the project leader. The last item in the worksheet is the Project Matrix (without the desired level of performance). An ‘X’ in one or more of the elements indicates that the project has an impact on that performance measurement and management function element of the matrix. The ‘X’ can be replaced with High, Medium, and Low or can be color coded to represent a calibration of the impact (based on the business unit's management system). Once the Individual Project Worksheets are completed, they are reviewed with the coordinator prior to further analytical work being performed.

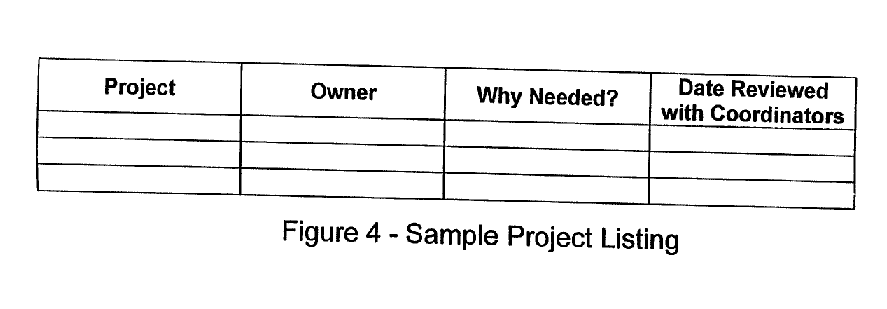

The Project Listing is a tracking tool to ensure the completeness of the business process and is portrayed in FIG. 4. The projects which are identified during interviews, workshops, research, process and attribute gap analysis, or a review of the integrated project management minutes are contained in the Project Listing. The business unit will assign a coordinator or coordinators to assist the consultants in completing and validating the Project Listing. These coordinators must be knowledgeable in most facets of the business to ensure that the data provided is complete in every respect. The consultants and coordinator(s) provide the Individual Project Worksheets (FIG. 3) to the project leaders.

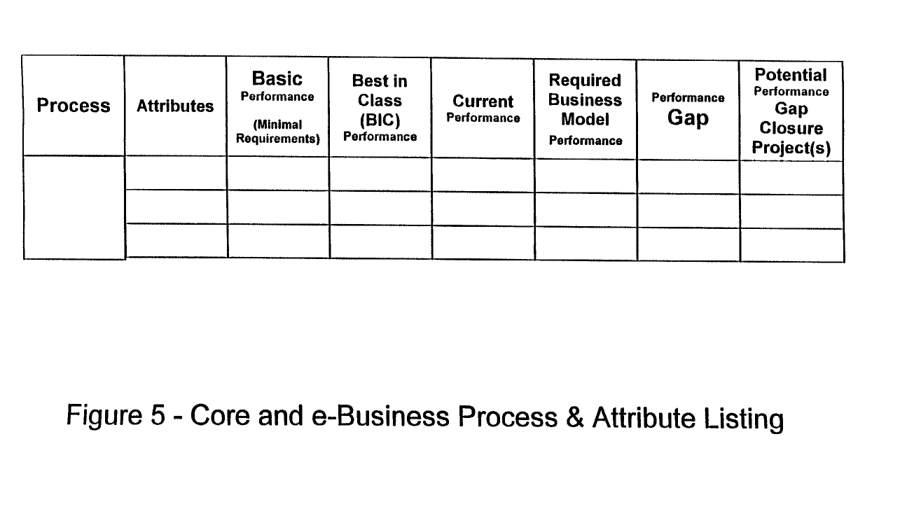

FIG. 5 represents the Core and e-Business Process and Attribute Listing. World-class companies lead with web-enabled deployments within their projects. The competitive metrics impacted are cost reductions, efficient use of resources, and improved operational responsiveness. Investment into transactional systems over the Internet are essential for performance and maintaining low expense to revenue (E/R) ratios. Web-enabled technologies support business-to-business (B2B) transactions in collaboration, procurement, replenishment, inventory levels, transportation, etc. A comparison to core and e-business processes and attributes is made in conjunction with the catalog of current and future projects. The Process & Attribute Listing should indicate the basic and best-in-class performance of each core and e-business process and attribute.

A gap analysis is conducted on those core and e-business processes and attributes that are critical to the business unit to emerge as a market and e-business leader. Each process is broken into attributes. Gaps are determined by subtracting the current performance level from the best-in-class performance, required performance, and/or the basic performance. In addition, FIG. 5 includes an entry for the potential to close any such gaps. The consultants and the business unit team must determine the value of those gaps and the required projects to close those gaps (current and required business model performance). The direction and magnitude of the current and required business model performance gap must be determined. Focus of effort should identify and rank negative gaps (current performance is less than required performance) in relation to the business model imperatives. This is another analytical tool to determine the impact of current projects and to identify additional projects to reduce the gaps. Current and additional projects have to be reprioritized within the Project Matrix and this business process.

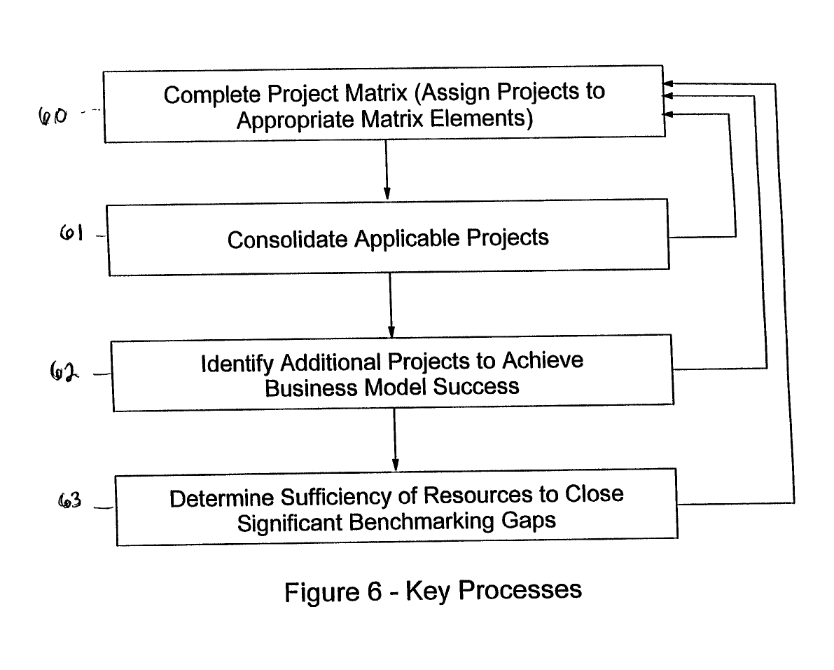

The optimal resource allocation business process and analytics applies the foregoing tools. The Key Processes are contained in flowchart form in FIG. 6. The key processes contain important features of the invention. The first major step 60 is the culmination of many preparatory events and the completion of the Project Matrix (FIG. 1). This completion includes the assignment of all known projects to specific performance measurements and management functions elements (referred to as matrix elements forthwith) of the Project Matrix. This information is found on the Individual Project Worksheets (FIG. 3) and is transferred verbatim to the Project Matrix (FIG. 1).

The second major step 61 is to consolidate applicable projects. One key criteria is to assess the number of projects within a matrix element. If, for example, there are more than a certain number (e.g., 5) of projects within an element, some or all of these projects are suitable for consolidation. There may be too many projects in this space that are consuming valuable resources and are expended in piece-meal fashion. Project proliferation may indicate a lack of focus, management control and leadership, and may require a reorganization or revised management system.

The intent of consolidation is to find synergistic effects, streamline execution, increase coordination, reduce costs, and ultimately achieve business objectives. Projects with a similar management domain (i.e., supply chain, distribution systems, etc.) or business objective should be consolidated for improved efficiencies and effectiveness.

The one major exception to this consolidation generalization is in the case of a business unit that is vertically integrated. For example, key components or services are produced by subsidiary business units which will require additional projects, particularly in the planning and execution business functions.

The third major step 62 is to identify additional projects to achieve business model success. If there are less than 2 projects within an element, then additional projects may be warranted to cover that performance measurement and management function space. The desired level of performance will establish the need for additional projects. For example, if world-class leadership is required, this would be a high priority for this matrix element. If comparable performance is required, the priority for covering this matrix element may be low to medium.

The one major exception to this sufficiency generalization is when that management function has been outsourced. When a particular function like manufacturing or distribution has been outsourced to a contract manufacturer or a third-party logistics provider, then the number of projects should be reduced. If this was a recent event, there may be transition projects in place to ensure that the new business relationship works. If there is a significant number of projects in these matrix elements, internal resources may be consumed and the outsourcing value-add may not be justified. A review of the contract between the company and the out-sourced manufacturer or third-party logistics provider is warranted prior to curtailing these projects. Another criteria is to assess the requirement for the outsourced contract.

The fourth major step 64 is to determine the necessity and sufficiency of resources to close significant benchmarking gaps. If a benchmarking study was not conducted, this step may be omitted. The gap analysis compares desired level of performance derived from the business model analysis and the actual performance identified in the benchmarking study. The goal would be to reallocate resources from those projects which have no significant performance gaps to those with the largest performance gaps and ensure world-class leadership and superior performance.

The benchmarking study may indicate that Performance Measurement One (PM1) has an actual performance of World-class Leadership when only Superior performance is desired. Performance Measurement Two (PM2) has an actual performance of worst-in-class and a Comparable performance is desired. In this case, some of the resources would be allocated from Performance Measurement One (PM1) to Performance Measurement Two (PM2), since this is the largest performance gap. The benchmarking study may indicate that Performance Measurement Three (PM3) has an actual performance of Superior when World-Class Leadership performance is required. Performance Measurement Four (PM4), an actual performance of Superior, and a Comparable performance is desired. In this case, some of the resources would be allocated from Performance Measurement Four (PM4) to Performance Measurement Three (PM3), since Performance Measurement Three (PM3) has the greatest need.

The above examples identify the direction and magnitude of each performance measurement benchmarking gap. Those benchmarking gaps, which have performance exceeding the business model performance, will have some of their extra assets placed in a resource pool. Those benchmarking gaps which have performance less than the desired level of performance will be recipients of some of the pooled resources. The resources are reallocated to the prioritized projects to close the largest benchmarking gaps whilst retaining world-class leadership focus.

The executives and consultants must ensure that this resource allocation is sufficient and necessary. Additional reprioritization and reallocations are warranted by going through the business process again. There may also be a disconnect between the business model (desired level of performance) and its local execution, indicating that a change in the business model should be considered or that the business model has not been clearly communicated throughout the organization.

Once the business process has been completed, it should be repeated based on the business unit's management system. The next iteration of this closed loop business process may identify changes in the business model, management functions and performance measurements. Therefore, this business process is adaptable to those changes in the business unit, and, hence, this is a repeatable business process and can leverage the work that was done during prior cycles.

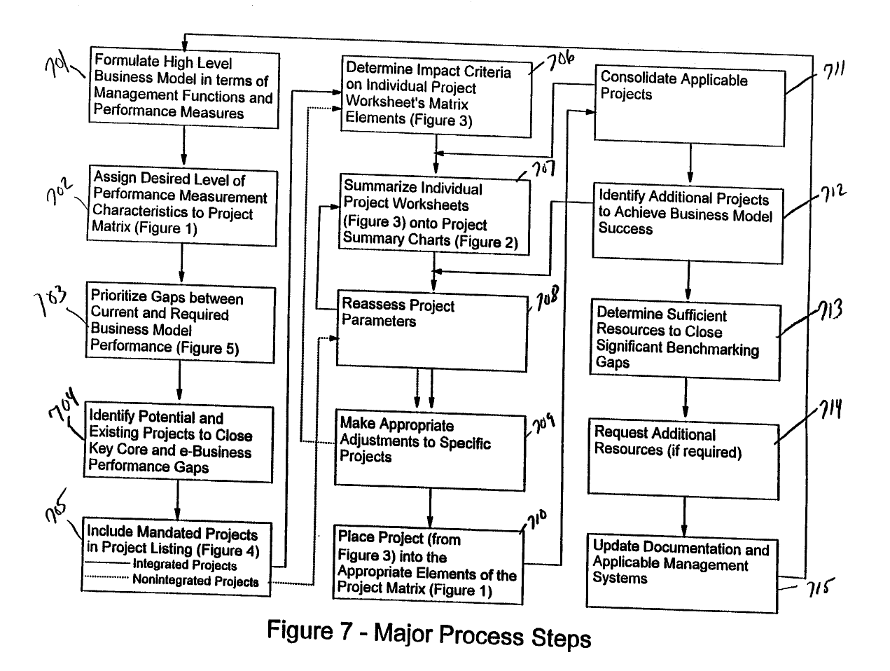

The process shown in FIG. 6 is expanded into Major Processes in the flowchart shown in FIG. 7. There are fifteen (15) major processes, which encompass the four key steps outlined above. The schematic provides some additional details on feedback loops within the business process. These feedback loops are required for reassessing the new information and decisions that have been made through the entire process. An important point is that there are sub-iterations or reassessments within the business process to ensure optimization. The ultimate goal is to achieve the current business model by having a coherent set of projects that have the optimal amount of resources.

Some of the major processes have been previously discussed with the exception of a few select processes to include mandated projects which have amplifying information contained below. The fifteen (15) major processes are as discussed below. In item 701, the invention formulates high level business models in terms of management functions and performance measures (FIG. 1). Some considerations when formulating the Project Matrix are basis of competition (technology, quality, price, cost, responsiveness, etc.), value proposition to customers, key technological innovations required, organizational structure (management system, hierarchical chain, matrix management, etc.), production environment (build to plan, build to order, engineer to order, configure to order, etc.), type of business (commodity (hard disk drives), complex configurations (high end servers), etc.), level of business integration, key management functions, and key performance measures.

In item 702, the invention assigns desired level of performance measurement characteristics to the Project Matrix (FIG. 1). Then, in item 703, the invention prioritizes gaps between current and required business model performance (FIG. 5). The invention identifies potential and existing projects to close key core and e-business performance gaps (FIG. 5). In item 705, the invention includes mandated projects in the project listing (FIG. 4). Next, in item 706, the invention determines impact criteria on Individual Project Worksheet (FIG. 3) matrix elements. In item 707, the invention summarizes Individual Project Worksheets (FIG. 3) onto Project Summary Charts (FIG. 2).

In item 708, the invention reassesses project parameters. The display of the various projects may identify other critical dependencies (sequential nature of the projects) or projects that must be executed in tandem (concurrently). The business process permits an enhanced planning process due to the complete knowledge of all ongoing and planned activities. The planning and execution processes are streamlined and synchronized due to continuous coordination required by the periodic management reviews. In item 709, the invention makes appropriate adjustments to specific projects, such as realigning project managers, adding skill resources, reorganization, and management system changes.

In item 710, the invention places these projects (from FIG. 3) into the appropriate elements of the Project Matrix (FIG. 1). Next, in item 711, the invention consolidates applicable projects. In item 712, the invention identifies additional projects to achieve business model success. Then, in item 713, the invention determines sufficient resources to close significant benchmarking gaps. Items 710 through 713 have been discussed above in items 60 through 63. In item 714, the invention requests additional resources (if required). Once the optimization business process reaches this point, any further resource shortfalls should be identified. A request for additional resources should be made, if required. If additional resources are not available, the business process should be restarted to optimize available resources. In item 715, the invention updates documentation and applicable management systems.

The tools should be reviewed and updated on a periodic basis as projects are completed, management decisions are made, and new projects are started. Critical priorities should be identified, specifically, those projects which lead to world-class leadership and superior performance, and close key gaps (benchmarking, process and attribute). The frequency of the reviews depends on the dynamic nature of the business and the business unit's management system. A strong and structured management system must be in place to take advantage of this business process. Periodic reassessments are essential to sustaining this improvement effort and obtaining the maximum benefit of the optimal resource allocation business process.

Mandated projects are external requirements that may be generated from enterprise-wide directives or governmental agencies. For example, a mandated project may result from a government regulation or the entire enterprise may be adopting one type of business application to promote consistency throughout the organization.

Of note is the differentiation between integrated and nonintegrated projects. From a planning and execution perspective, integrated projects have been previously coordinated with other projects where nonintegrated projects have not. Based upon this differentiation, two different process flows are required but, ultimately, arrive together when the Project Matrix is produced.

By utilizing the invention, these mandated requirements can be examined for prioritization and finding in conjunction with the business model needs. By exercising these external requirements within the business process framework, performance impacts, gap closure or funding cases can be developed as a part of the business process. This results in dramatically improving and integrating the local deployment of enterprise level, government regulation requirements, and business unit projects. Additionally, the invention highlights enterprise level projects or governmental mandates which may not be supportive of the business unit's objectives. This type of issue must be addressed and harmonized with all ongoing activities.

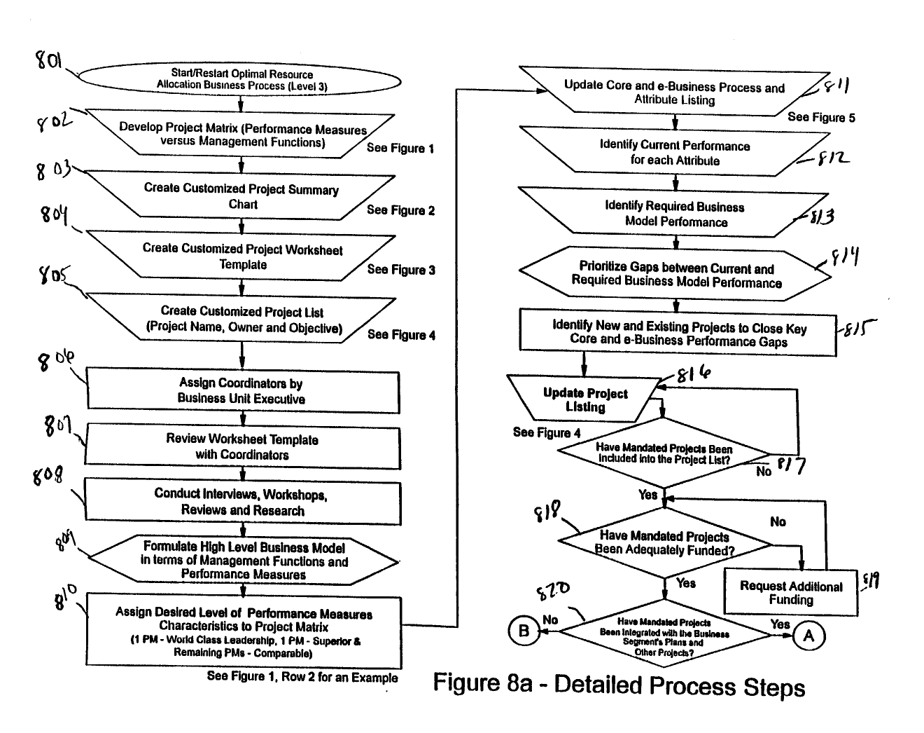

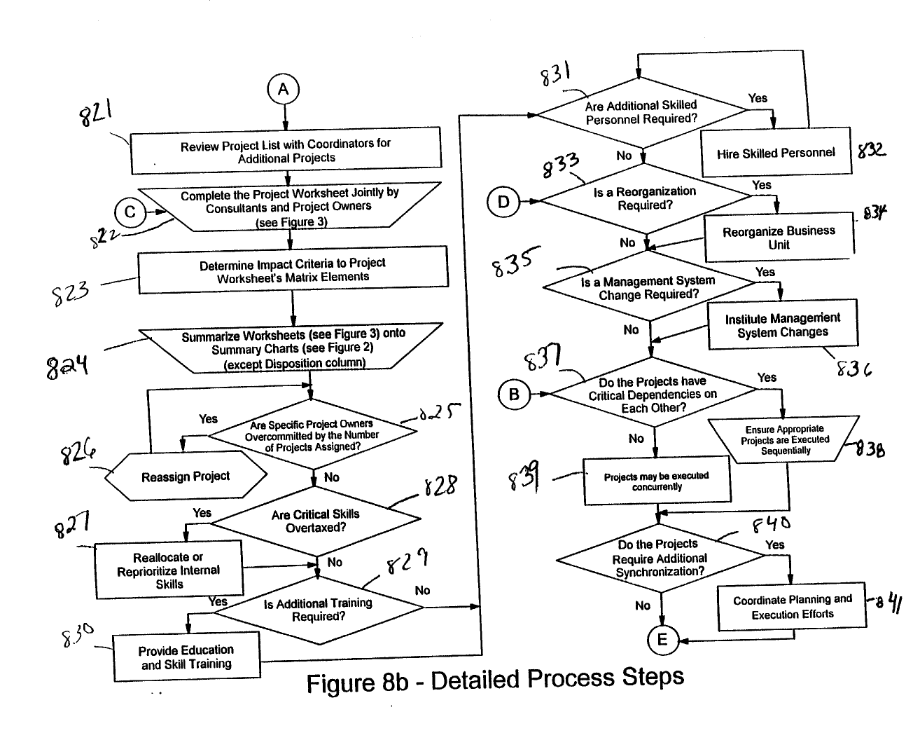

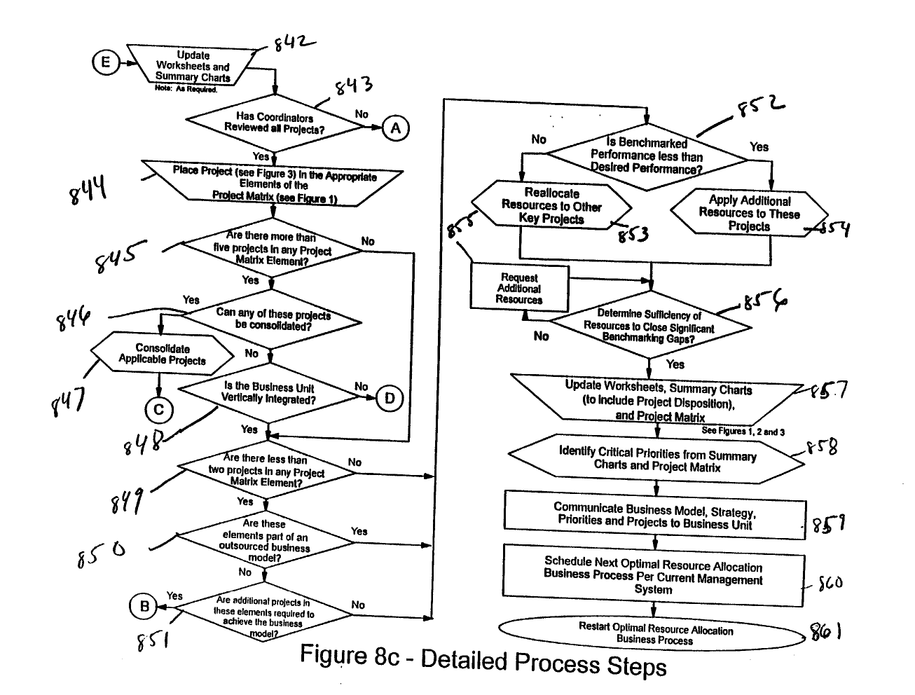

Detailed processes of the invention are shown in flowchart in FIGS. 8a, 8b, and 8c. More specifically, in item 801, the invention starts/restarts the inventive optimal allocation business process. In item 802, the invention develops a project matrix (Performance Measures versus Management Functions) as discussed above with respect to FIG. 1. In item 803, the invention creates a customized project summary chart as discussed above with respect to FIG. 2. In item 804, the invention creates a customized project worksheet template as discussed above with respect to FIG. 3. In item 805, the invention creates a customized project list (project name, owner and objective) as discussed above with respect to FIG. 4. In item 806, the invention assigns coordinators by Business Unit Executive. In item 807, the invention reviews a worksheet template with coordinators. In item 808, the invention conducts interviews, workshops, reviews and researches. In item 809, the invention formulates a high level business model in terms of management functions, performance measures, and criteria discussed above. In item 810, the invention assigns the desired level of performance measure characteristics to the project matrix as discussed above with respect to FIG. 1.

In item 811, the invention updates the core and e-Business process and attributes listing as discussed above with respect to FIG. 5. In item 812, the invention identifies current performance for each attribute. In item 813, the invention identifies the required business model performance. In item 814, the invention prioritizes gaps between current and required business model performance. In item 815, the invention identifies new and existing projects to close key core and e-Business performance gaps. The invention updates the project listing in item 816 with respect to FIG. 4.

If the mandated projects have been included into the project list (item 817), the process proceeds to item 818. If not, processing returns to item 816. If projects are adequately funded (item 818), processing proceeds to item 820. If they are not funded, a request is made for additional funding (item 819). In item 820, the invention determines whether mandated projects have been integrated with the business segment's plans and other projects. If they have been, the invention proceeds to item 837 (B) discussed below with respect to FIG. 8b. If they have not been integrated, the invention proceeds to item 821 (A) in FIG. 8b.

In FIG. 8b, the invention reviews the project list with coordinators for additional projects (item 821). Next in item 822, the invention completes the project worksheet jointly by consultants and project owners as discussed above with respect to FIG. 3. In item 823, the invention determines impact criteria to the project worksheet's matrix elements. In item 824, the invention summarizes the worksheets (as discussed above with respect to FIG. 3) onto summary charts (as discussed above with respect to FIG. 2), except for the disposition column. If specific project owners are over-committed by the number of projects assigned (item 825), the invention reassigns the project (item 826), and the processing returns to item 825. If the owners are not over-committed, the invention proceeds to item 828 which determines if critical skills are overtaxed. If the skills are overtaxed, the invention reallocates or reprioritizes internal skills (item 827). If critical skills are not overtaxed, the invention determines if additional training is required (item 829). If training is required, the invention provides education and skill training (item 830). If additional training is not required (item 829), the invention determines whether additional skilled personnel are required (item 831). If personnel are required, the invention hires skilled personnel (item 832) and processing returns to item 831. If additional skills are not required, the invention determines whether a reorganization is required (item 833). If reorganization is required, the invention reorganizes a business unit (item 834). If no reorganization is required, the invention determines whether a management system change is required (item 835). If a management system change is required, the invention institutes management system changes (item 836) and processing returns to item 837. If no management system changes are required, the invention determines if the projects have critical dependencies on each other (item 837). If the projects have critical dependencies on each other, the invention ensures that appropriate projects are executed sequentially (item 838) and processing skips to item 840. If the projects do not have critical dependencies on each other, the projects may be executed concurrently (item 839).

In item 840, the invention determines if projects require additional synchronization. If they require additional synchronization, the invention coordinates planning and execution efforts (item 841). If no additional synchronization is needed, processing proceeds to item 842 (E), discussed below with respect to FIG. 8c.

In FIG. 8c, the invention updates worksheets and summary charts as required (item 842). If coordinators have reviewed all of the projects (item 843), the invention places the project (as discussed above with respect to FIG. 3) in the appropriate elements of the project matrix (as discussed above with respect to FIG. 1) (item 844). If coordinators have not reviewed all projects, the processing returns to item 821 (A).

Next, in item 845, the invention determines if there are more than five projects in any project matrix element. If there are, it must then be decided if any of these projects can be consolidated (item 846). If they can be consolidated, the invention consolidates applicable projects (item 847) and returns to item 822 (C). If there are not more than five projects in any project matrix element, processing skips forward to item 849, discussed below. If projects cannot be consolidated, the invention determines if the business unit is vertically integrated (item 848). If it is not vertically integrated, the processing returns to item 833 (D). If the unit is vertically integrated, the invention determines if there are less than two projects in any project matrix element (item 849). If there are not less than two, processing skips forward to item 852, discussed below. If there are less than two elements, the invention determines if the elements are part of an outsourced business model (item 850). If the elements are part of an outsourced business model, processing skips forward to item 852, discussed below. If the elements are not part of an outsource business model, the invention determines if additional projects in these elements are required to achieve the business model (item 851). If additional projects are required, the processing returns to item 837 (B), as discussed above. If additional projects are not required to achieve the business model, the invention determines if benchmarked performance is less than desired performance (item 852). If benchmarked performance is less than desired performance, the invention applies additional resources to these projects (item 854). If benchmarked performance is not less than desired performance, the invention reallocates resources to other key projects (item 853).

Then, in item 856, the invention determines the sufficiency of resources to close significant benchmarking gaps. If there are not sufficient resources, the invention requests additional resources (item 855). If there are sufficient resources, the invention updates worksheets and summary charts (item 857) to include project disposition and the project matrix as discussed above with respect to FIGS. 1, 2 and 3. In item 858, critical priorities will be identified from the Project Matrix (as discussed above with respect to FIG. 1) and Summary Charts (as discussed above with respect to FIG. 2). These critical priorities can be derived from the world class leadership and superior performance desired level of performance measurements, and those projects consuming significant resources. In item 859, the invention communicates business model, strategy, priorities and projects to the business unit. In item 860, the invention schedules the next optimal resource allocation business process per current management system. In item 861, the invention restarts the optimal resource allocation business process.

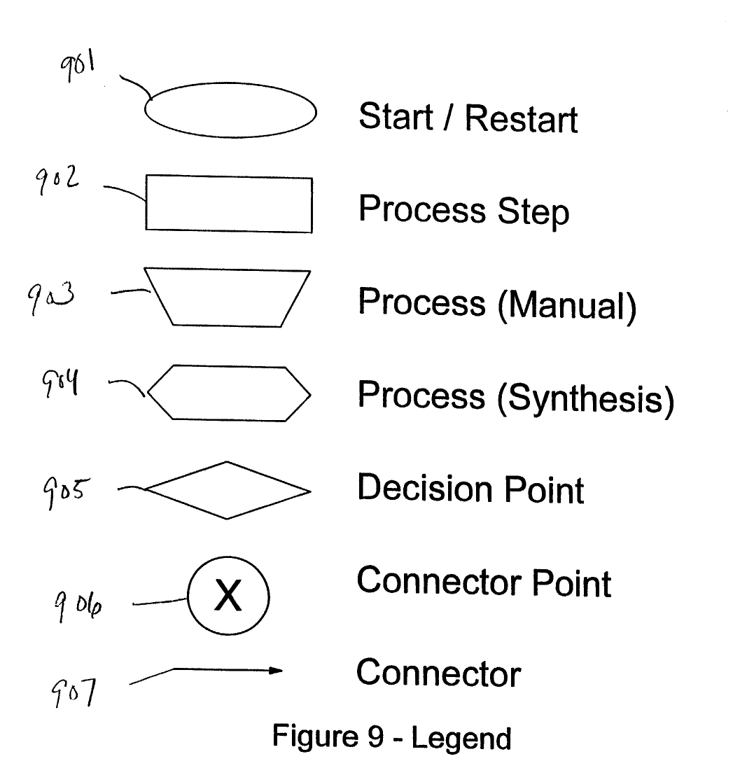

A legend for the process flows of FIGS. 8a-8c is contained in FIG. 9. More specifically, item 901 shows the shape for the start/restart processes. Item 902 shows the shape for a process step. Item 903 shows the shape for a manual process step. Item 904 shows the shape for the process synthesis. Item 905 shows the shape for a decision point. Item 906 shows the shape for a connector point. Item 907 shows the shape for a connector.

The detailed process flowcharts provide the logic behind the business process and clarifies the sequence of specific process steps to include key decision points, synthesis events (where data and information are transformed into actionable intelligence using a set of criteria), and several critical feedback/reassessment loops.

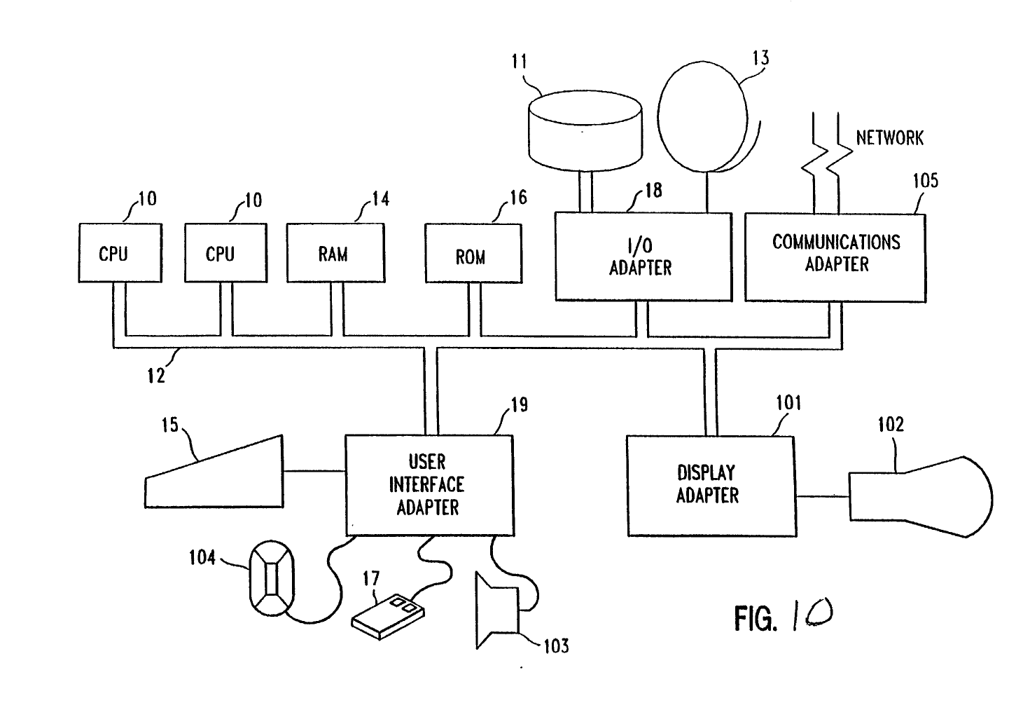

A representative hardware environment for practicing the present invention is depicted in FIG. 10, which illustrates a typical hardware configuration of an information handling/computer system in accordance with the subject invention, having at least one processor or central processing unit (CPU) 10. CPUs 10 are interconnected via system bus 12 to random access memory (RAM) 14, read-only memory (ROM) 16, an input/output (I/O) adapter 18 for connecting peripheral devices, such as disk units 11 and tape drives 13, to bus 12, user interface adapter 19 for connecting keyboard 15, mouse 17, speaker 103, microphone 104, and/or other user interface devices such as touch screen device (not shown) to bus 12, communication adapter 105 for connecting the information handling system to a data processing network, and display adapter 101 for connecting bus 12 to display device 102. A program storage device readable by the disk or tape units, is used to load the instructions which operate on a wiring interconnect design which is also loaded onto the computer system.

The invention identifies additional key owners by management function. Projects may be started by one executive, but due to the inter-disciplinary nature of problems, require the buy-in of other executives. For example, those projects that pertain to inventory should have the backing and financial support of the Chief Financial Officer (CFO) even though it was started by an executive in procurement or business planning. This business process provides a forum for this coordination, and ensures internal buy-in and cross-functional sponsorship which is essential for success.

The optimal resource allocation business process promotes business model consistency. Portions of the overall business model (strategy) (in house, outsourced, etc.) should be readily identifiable in the Project Matrix. All projects must be properly aligned to the business model (strategy) to achieve a competitive advantage. On occasion, this business process may be used to reassess a prior business model decision (e.g., revisit an outsourcing or vertical integration decision). This business process provides a consistent framework for evaluating business configurations.

The Project Matrix, tools, criteria, and analysis ensure that the projects are in alignment with the business model, close sized performance gaps, and have sufficient sponsorship within the organization. When groups of projects are out of balance with the business model, management intervention is warranted. By reviewing the projects in the context of this optimal resource allocation business process, and how they relate to each other, all of the management functions and performance measurements will be considered in their proper context, resulting in the right set of projects being committed to achieve the business model. Additionally, the invention links the business model and projects together to ensure that an end-to-end core and e-business structure is planned and implemented.

While the invention has been described in terms of preferred embodiments, those skilled in the art will recognize that the invention can be practiced with modification within the spirit and scope of the appended claims.

What is claimed is:

1. A method of evaluating projects comprising:
completing a project matrix by assigning projects to matrix elements;
consolidating selected projects within said matrix elements; and
identifying any additional projects necessary to supplement projects within said matrix elements based on matrix coverage after said consolidation process.

2. The method of claim 1, further comprising determining a sufficiency of resources to close benchmarking gaps between desired performance levels and actual performance levels.

3. The method in claim 1, wherein said process of completing said project matrix comprises:
establishing desired performance levels for each of said performance measures; and
determining actual performance levels achieved for a plurality of performance measures.

4. The method in claim 3, further comprising comparing said actual performance levels and said desired performance levels to identify said benchmarking gaps.

5. The method in claim 3, further comprising determining said actual performance levels achieved for management functions, wherein each of said performance measures includes a plurality of said management functions.

6. The method in claim 5, wherein said project matrix includes between 3 and 6 of said performance measures and between 3 and 6 of said management functions.

7. The method in claim 3, wherein:
said actual performance levels include: inferior, comparable, superior, and world-class leadership, and
said desired performance levels include: comparable, superior, and world-class leadership.

8. The method in claim 7, wherein one of said performance measures has a world-class leadership desired performance level, one of said performance measures has a superior desired performance level, and remaining ones of said performance measures have comparable desired performance levels.

9. The method in claim 1, wherein said consolidating process and said process of identifying additional projects limits a number of projects within each of said matrix elements to maintain management focus.

10. A method of evaluating projects comprising:
completing a project matrix by assigning projects to matrix elements, wherein said matrix elements comprise performance measures, each associated with a plurality of management functions;
establishing desired performance levels for said performance measures;
determining actual performance levels achieved for each of said management functions within each of said performance measures;
comparing said actual performance levels and said desired performance levels to identify benchmarking gaps; and
determining a sufficiency of resources to close said benchmarking gaps.

11. The method in claim 10, further comprising:
consolidating selected projects within said matrix elements; and
identifying any additional projects necessary to supplement projects within said matrix elements based on matrix coverage after said consolidation process.

12. The method in claim 11, wherein said consolidating process and said process of identifying additional projects limits a number of projects within each of said matrix elements to maintain management focus.

13. The method in claim 10, wherein each of said performance measures includes more than one of said management functions.

14. The method in claim 10, wherein said project matrix includes between 3 and 6 of said performance measures and between 3 and 6 of said management functions.

15. The method in claim 10, wherein:
said actual performance levels include: inferior, comparable, superior, and world-class leadership, and
said desired performance levels include: comparable, superior, and world-class leadership.

16. The method in claim 15, wherein one of said performance measures has a world-class leadership desired performance level, one of said performance measures has a superior desired performance level, and remaining ones of said performance measures have comparable desired performance levels.

17. A method of evaluating projects comprising:
completing a project matrix by assigning projects to matrix elements, wherein said matrix elements comprise performance measures, each associated with a plurality of management functions;
establishing desired performance levels for said performance measures, wherein one of said performance measures has a highest desired performance level, one of said performance measures has a second highest performance level and remaining ones of said performance measures have a third highest desired performance level;
determining actual performance levels achieved for each of said management functions within each of said performance measures;
comparing said actual performance levels and said desired performance levels to identify benchmarking gaps; and
determining a sufficiency of resources to close said benchmarking gaps.

18. The method in claim 17, further comprising:
consolidating selected projects within said matrix elements; and
identifying any additional projects necessary to supplement selected projects within said matrix elements based on matrix coverage after said consolidation process.

19. The method in claim 18, wherein said consolidating process and said process of identifying additional projects limits a number of projects within each of said matrix elements to maintain management focus.

20. The method in claim 17, wherein each of said performance measures includes more than one of said management functions.

21. The method in claim 17, wherein said project matrix includes between 3 and 6 of said performance measures and between 3 and 6 of said management functions.

22. The method in claim 17, wherein:
said actual performance levels include: inferior, comparable, superior, and world-class leadership, and
said desired performance levels include: comparable, superior, and world-class leadership.

23. The method in claim 22, wherein one of said performance measures has a world-class leadership desired performance level, one of said performance measures has a superior desired performance level and remaining ones of said performance measures have comparable desired performance levels.

24. A program storage device readable by machine, tangibly embodying a program of instructions executable by the machine to perform a method of evaluating projects comprising:
completing a project matrix by assigning projects to matrix elements;
consolidating selected projects within said matrix elements; and
identifying any additional projects necessary to supplement projects within said matrix elements based on matrix coverage after said consolidation process.

25. The method of claim 24, further comprising determining a sufficiency of resources to close benchmarking gaps between desired performance levels and actual performance levels.

26. The program storage device in claim 24, wherein said process of completing said project matrix comprises:
establishing desired performance levels for each of said performance measures; and
determining actual performance levels achieved for a plurality of performance measures.

27. The program storage device in claim 26, wherein said method further comprises comparing said actual performance levels and said desired performance levels to identify said benchmarking gaps.

28. The program storage device in claim 26, wherein said method further comprises determining said actual performance levels achieved for management functions, wherein each of said performance measures includes a plurality of said management functions.

29. The program storage device in claim 28, wherein said project matrix includes between 3 and 6 of said performance measures and between 3 and 6 of said management functions.

30. The program storage device in claim 24, wherein:
said actual performance levels include: inferior, comparable, superior, and world-class leadership, and
said desired performance levels include: comparable, superior, and world-class leadership.

31. The program storage device in claim 26, wherein one of said performance measures has a world-class leadership desired performance level, one of said performance measures has a superior desired performance level, and remaining ones of said performance measures have comparable desired performance levels.

32. The program storage device in claim 24, wherein said consolidating process and said process of identifying additional projects a number of projects within each of said matrix elements to maintain management focus.
